(19) United States
(12) Patent Application Publication
(10) Pub. No.: US 2018/0252017 A1
(43) Pub. Date: Sep. 6, 2018

(54) VEHICLE DOOR OPENING AND CLOSING CONTROL DEVICE

(71) Applicants: Yoshie Hayashi, Aichi (JP); Hirohito Miyazaki, Gifu (JP); Kenshin Oh, Aichi (JP)

(72) Inventors: Yoshie Hayashi, Aichi (JP); Hirohito Miyazaki, Gifu (JP); Kenshin Oh, Aichi (JP)

(73) Assignee: OMRON AUTOMOTIVE ELECTRONICS CO., LTD., Aichi (JP)

(21) Appl. No.: 15/885,607

(22) Filed: Jan. 31, 2018

(30) Foreign Application Priority Data
Mar. 1, 2017 (JP) 2017-038057

(51) Int. Cl. E05F 15/73; B60J 5/10

(52) U.S. Cl. CPC E05F 15/73; E05Y 2900/546; B60J 5/10

(57) ABSTRACT

A vehicle door opening and closing control device includes a sensor, a determining unit, and a controller. When after an output value of the sensor reaches a threshold, a period in which the output value of the sensor exceeds the threshold continues for not less than a fixed time, and then the output value of the sensor falls below the threshold, the determining unit compares a first output value of the sensor before the output value of the sensor exceeds the threshold and a second output value of the sensor after the output value of the sensor falls below the threshold. When both the first output value and the second output value satisfy a predetermined condition, the determining unit determines that a predetermined motion to be detected by the sensor is performed.

### CROSS-REFERENCE TO RELATED APPLICATION

This application is based on Japanese Patent Application No. 2017-038057 filed with the Japan Patent Office on Mar. 1, 2017, the entire contents of which are incorporated herein by reference.

### FIELD

The disclosure relates to a vehicle door opening and closing control device that detects a predetermined motion of a body part such as a leg and opens and closes a door of a vehicle.

### BACKGROUND

A door opening and closing system is known which is capable of detecting a predetermined motion of a leg of a user and automatically opening or closing a sliding door or a back door of a vehicle even in a case where the user opens or closes the door while holding baggage with both hands.

For example, JP 2014-500414 W discloses a door opening and closing system which includes a first sensor and a second sensor disposed at different places at a rear of a vehicle, and detects a leg motion. This door opening and closing system detects a time difference between a signal output from the first sensor and a signal output from the second sensor. In a case where the time difference satisfies a predetermined criterion, the door opening and closing system determines that a kicking motion of a leg (motion of swinging the leg such that the toe enters between a vehicle body and the ground) is performed, and opens a back door of the vehicle.

In addition, JP 2016-100099 A discloses a door opening and closing system using a capacitive sensor including two electrodes, as a sensor for detecting a leg motion. This door opening and closing system measures a capacitance value detected by a first electrode and a capacitance value detected by a second electrode. The door opening and closing system detects a predetermined leg motion according to the result of comparison between change amounts of the respective capacitance values, and opens or closes a door of a vehicle.

FIG. 15 is a view for explaining a detection principle of a kicking motion of a leg. In FIG. 15, a kick sensor 50 is provided at a lower rear part of a vehicle V. The kick sensor 50 is, for example, a capacitive proximity sensor and has a detection area indicated by a broken line. When a user opens or closes a back door (not illustrated) of the vehicle V, a user stands behind the vehicle V and performs a kicking motion of a leg F at a location facing the kick sensor 50. In this kicking motion, the position of the leg F changes in the following order: P1, P2, P3, P2, P1.

FIG. 16 illustrates a waveform of a signal output from the kick sensor 50 according to a change in position of the leg F. At a position P1, since the leg F does not enter the detection area, the kick sensor 50 does not detect the leg F. At that time, the output value (voltage) of the kick sensor 50 is a preset offset value. At a position P2, the leg F starts to enter the detection area and the output value rises. However, the output value does not exceed a threshold. When the user further swings the leg F forward, the leg F approaches the kick sensor 50, and the output value exceeds the threshold at some time point. Then, at a position P3, the leg F approaches closest to the kick sensor 50, and the output value becomes maximum. Then, when the user pulls the leg F backward to the position P2, the output value falls below the threshold. When the leg F has landed and located at the position P1, the output value returns to the offset value.

Conventionally, in FIG. 16, a kicking motion of the leg F is detected on condition that the output value of the kick sensor 50 rises over and falls below the threshold. Specifically, a temporal change in the signal output from the kick sensor 50 is monitored. It is determined that a kicking motion of the leg F is performed in the following case. After the output value of the sensor rises and reaches the threshold, a time period Ton in which the output value exceeds the threshold continues for a fixed time period or longer, and then the output value lowers and falls below the threshold.

The kick sensor does not always detect only a kicking motion. The kick sensor may detect a motion of the leg other than a kicking motion. For example, in a case where the user approaches the rear part of the vehicle by walk, even though the leg motion of the user is not a kicking motion, the kick sensor may detect up and down of the leg during walking, and the output value of the kick sensor may rise over and fall below the threshold. Similarly, in a case where an animal such as a dog or a cat approaches the rear part of the vehicle and then moves away from the rear part, the output value of the kick sensor may rise over and fall beyond the threshold. Therefore, in the conventional method, there is a possibility that a motion other than a regular kicking motion will be erroneously detected as a kicking motion, and there is a problem that detection accuracy lowers.

### SUMMARY

Therefore, an object of the disclosure to reduce the likelihood that a motion of a body part such as a leg will be erroneously detected and to improve detection accuracy.

A vehicle door opening and closing control device according to one or more embodiments of the disclosure includes: a sensor provided near a door of a vehicle and configured to detect a motion of a body part of a user; a determining unit configured to determine whether or not the motion that the sensor detects is a predetermined motion; and a controller configured to perform an opening operation or a closing operation of the door of the vehicle in a case where the predetermined motion is performed. A threshold is set for an output value of the sensor. In a case where after the output value of the sensor reaches the threshold, a period in which the output value of the sensor exceeds the threshold continues for not less than a fixed time, and then the output value of the sensor falls below the threshold, the determining unit compares a first output value of the sensor before the output value of the sensor exceeds the threshold and a second output value of the sensor after the output value of the sensor falls below the threshold. In a case where both the first output value and the second output value satisfy a predetermined condition, the determining unit determines that the predetermined motion is performed.

According to the above vehicle door opening and closing control device, the determining unit does not determine that the predetermined motion such as a kicking motion is performed in the following case. In the case, the first output value before the output value of the sensor exceeds the threshold and the second output value after the output value of the sensor falls below the threshold do not satisfy the predetermined condition even in a case where a conventional determination condition is satisfied. The conventional determination condition is that the output value of the sensor reaches the threshold, the period in which the output value of the sensor exceeds the threshold continues for not less than the fixed time, and then the output value falls below the threshold. Therefore, erroneous determination for a motion other than the predetermined motion is avoided, and detection accuracy is improved.

In one or more embodiments of the disclosure, the determining unit may determine that the predetermined condition is satisfied in a case where the absolute value of the difference between the first output value and the second output value is not greater than a predetermined value. The determining unit may determine that the predetermined condition is not satisfied in a case where the absolute value of the difference between the first output value and the second output value is greater than the predetermined value.

In one or more embodiments of the disclosure, the first output value may be a first offset value that the sensor outputs in a state where the sensor does not detect the motion of the body part, and the second output value may be a second offset value that the sensor outputs in a state where the sensor does not detect the motion of the body part.

In one or more embodiments of the disclosure, the vehicle door opening and closing control device may further include a calculator configured to calculate the first offset value and the second offset value. The calculator may calculate the first offset value by calculating an average value of output values of the sensor in a predetermined first period before the output value of the sensor exceeds the threshold. The calculator may calculate the second offset value by calculating an average value of output values of the sensor in a predetermined second period after the output value of the sensor falls below the threshold.

In one or more embodiments of the disclosure, the calculator may calculate the first offset value by using a moving average of output values in the predetermined first period. In this case, the first offset value may be a value calculated immediately before the increase rate of the output value of the sensor exceeds a fixed value.

In one or more embodiments of the disclosure, the calculator may calculate the second offset value by using a simple average of output values in the predetermined second period.

In one or more embodiments of the disclosure, in a case where the predetermined condition is satisfied, the determining unit may determine that a motion detected by the sensor is a kicking motion of a leg.

According to one or more embodiments of the disclosure, it is possible to reduce the likelihood that a motion of a body part such as a leg will be erroneously detected and to improve detection accuracy.

### BRIEF DESCRIPTION OF THE DRAWINGS

FIG. 1 is a rear view of a vehicle on which a vehicle door opening and closing control device is mounted.

FIG. 2 is a partial side view of the vehicle in FIG. 1.

FIG. 3 is a block diagram of the vehicle door opening and closing control device.

FIGS. 4A to 4E are views illustrating leg motions of a kicking motion.

FIG. 5 is a waveform diagram of a signal output from a kick sensor according to the leg motions in FIGS. 4A to 4E.

FIG. 6 is another example of the waveform diagram of the signal output from the kick sensor.

FIGS. 7A to 7E are views illustrating leg motions other than the kicking motion.

FIG. 8 is a waveform diagram of a signal output from the kick sensor according to the leg motions in FIGS. 7A to 7E.

FIG. 9 is another example of the waveform diagram of the signal output from the kick sensor.

FIG. 10 is a flowchart illustrating a procedure of kicking motion detection.

FIG. 11 is a flowchart illustrating a procedure of opening or closing a back door.

FIG. 12 is a diagram illustrating a method of calculating a first offset value.

FIG. 13 is a diagram illustrating the method of calculating the first offset value.

FIG. 14 is a diagram illustrating a method of calculating a second offset value.

FIG. 15 is a view for explaining a principle of detecting a kicking motion.

FIG. 16 is a waveform diagram of a signal output from a kick sensor.

### DETAILED DESCRIPTION

Hereinafter, embodiments of the disclosure will be described with reference to the drawings. In the drawings, identical or corresponding parts are denoted by identical reference signs. In embodiments of the disclosure, numerous specific details are set forth in order to provide a more through understanding of the invention. However, it will be apparent to one of ordinary skill in the art that the invention may be practiced without these specific details. In other instances, well-known features have not been described in detail to avoid obscuring the invention.

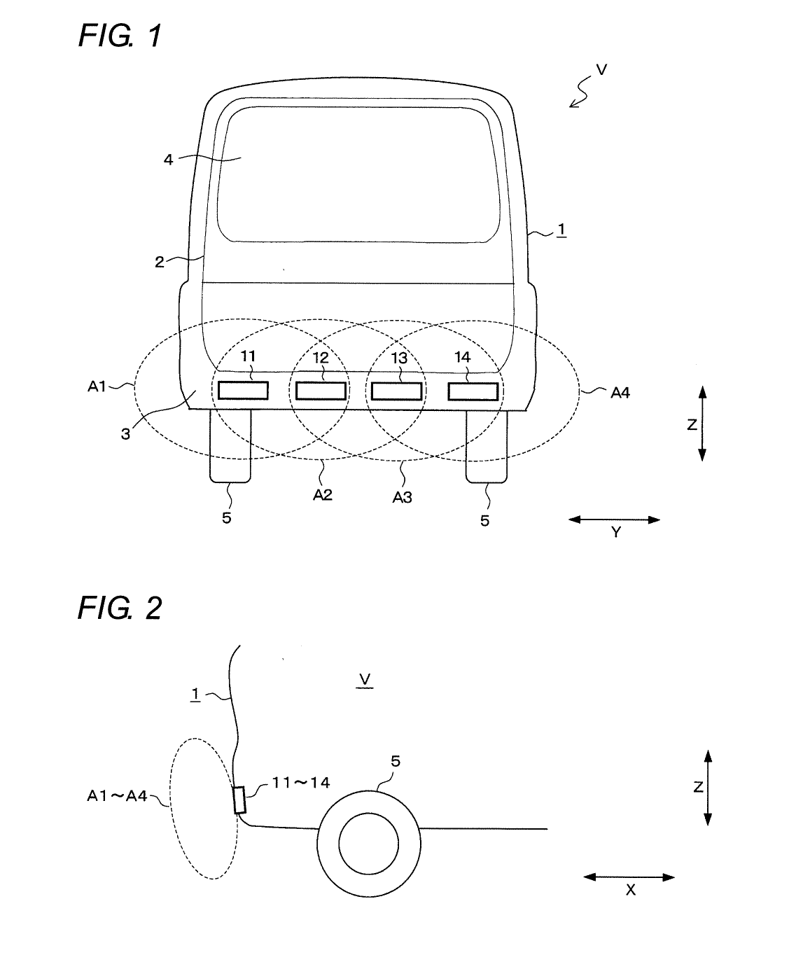

First, a configuration of a vehicle door opening and closing control device will be described with reference to FIGS. 1 to 3. FIG. 1 is a view of a vehicle V as viewed from the rear, and FIG. 2 is a view of the vehicle V as viewed from a side. In the drawings, arrow X represents the front-rear direction, arrow Y represents the right-left direction, and arrow Z represents the up-down direction.

In FIGS. 1 and 2, the vehicle V is a passenger car and includes a vehicle body 1, a back door 2, a rear bumper 3, a rear window 4, tires 5, and a plurality (four in this case) of kick sensors 11 to 14, and the like.

The kick sensors 11 to 14 are sensors for detecting a kicking motion of a leg of a user according to approach and separation of the leg of a user. Each of the kick sensors 11 to 14 is configured of, for example, a capacitive proximity sensor. The kick sensors 11 to 14 are arranged on the rear bumper 3 near the back door 2, at predetermined intervals in the horizontal direction (Y direction). The kick sensors 11 to 14 have detection areas A1 to A4 indicated by broken lines, respectively. Note that the kick sensors 11 to 14 are not necessarily arranged in the Y direction and may be arranged in the X direction, for example.

As illustrated in FIG. 1, each of the detection areas A1 to A4 extends in the right-left direction Y and the up-down direction Z, and also extends in the front-rear direction X as illustrated in FIG. 2. As can be seen from FIG. 1, the detection areas of the adjacent kick sensors partially overlap each other in the arrangement direction of the kick sensors (Y direction).

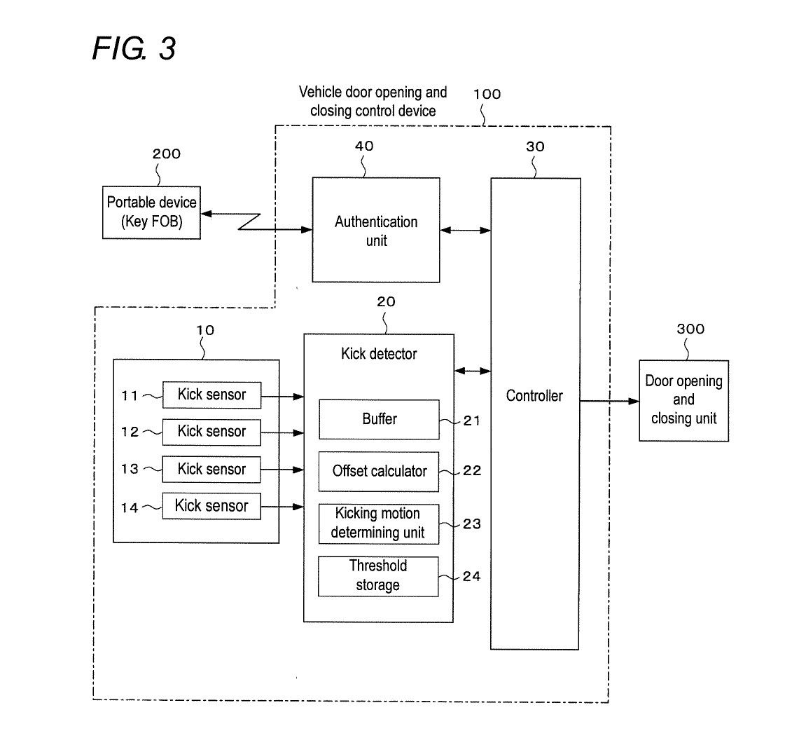

FIG. 3 is a block diagram illustrating an example of the electrical configuration of the vehicle door opening and closing control device. The vehicle door opening and closing control device 100 is mounted on the vehicle V in FIG. 1, and includes a sensor 10, a kick detector 20, a controller 30, and an authentication unit 40. Note that FIG. 3 illustrates only blocks related to one or more embodiments of the disclosure.

The sensor 10 is configured of the above-described kick sensors 11 to 14. The kick detector 20 detects a kicking motion according to output from the sensor 10. The kick detector 20 includes a buffer 21, an offset calculator 22, a kicking motion determining unit 23, and a threshold storage 24. The offset calculator 22 corresponds to a “calculator” in one or more embodiments of the disclosure, and the kicking motion determining unit 23 corresponds to a “determining unit” in one or more embodiments of the disclosure.

The controller 30 is configured of a CPU, a memory, and the like. In a case where the kick detector 20 detects a kicking motion, the controller 30 controls a door opening and closing unit 300, and opens or closes the back door 2 (FIG. 1) of the vehicle V.

The door opening and closing unit 300 is configured of a motor for opening and closing the back door 2, an actuator for locking and unlocking the back door 2, a drive circuit for driving the motor and the actuator, and the like (not illustrated).

A portable device 200 carried by a user includes an operation unit configured of a key FOB and operated by the user, a communicator which communicates with the authentication unit 40, and the like (not illustrated).

The authentication unit 40 communicates with the portable device 200 and authenticates the portable device 200. Specifically, when the user approaches the vehicle V, the authentication unit 40 requests the portable device 200 to transmit identification information. The identification information is, for example, a key ID assigned to the portable device 200. Then, the authentication unit 40 collates the identification information received from the portable device 200 with identification information stored in advance, and authenticates whether or not the portable device 200 is an authorized portable device according to the collation result. The authentication unit 40 also includes a communicator that communicates with the portable device 200, a storage that stores identification information of the portable device 200, and the like (not illustrated).

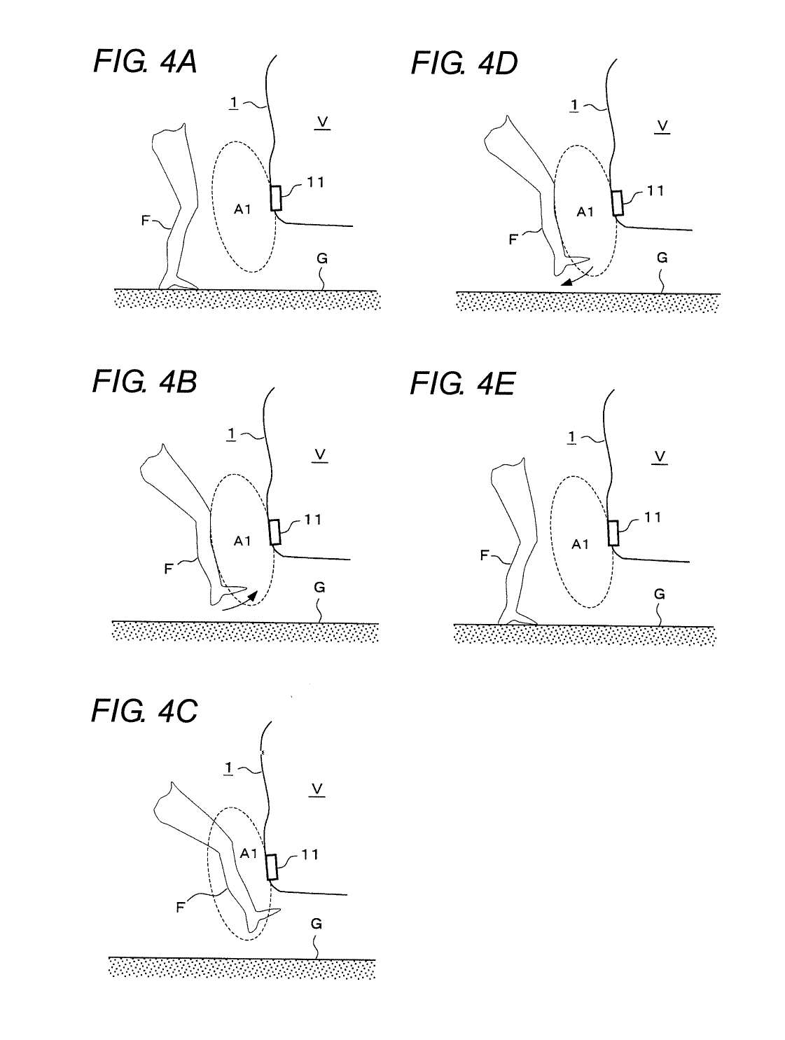

Next, details of the kicking motion will be described. FIGS. 4A to 4E illustrate leg motions of a regular kicking motion. Each of FIGS. 4A to 4E illustrates only the kick sensor 11 from among the kick sensors 11 to 14 in FIG. 1 and the detection area Al of the kick sensor 11. When the user opens or closes the back door 2 (FIG. 1), the user stands behind the vehicle V and performs a kicking motion at a location facing the kick sensor 11.

FIG. 4A illustrates a state immediately before the user swings the leg F forward. In this state, since the leg F does not enter the detection area A1, the kick sensor 11 does not detect the leg F. FIG. 4B illustrates a state immediately after the user swings the leg F forward and the leg F has entered the detection area A1. In this state, the kick sensor 11 detects the leg F. However, at this time point, since the kick sensor 11 only detects part of the leg F, the output value of the kick sensor 11 is small.

FIG. 4C illustrates a state where the user further swings the leg F forward and the toe has entered between the vehicle body 1 and the ground G. In this state, the leg F remains to be in the detection area A1, and the kick sensor 11 continuously detects the leg F. Since the leg F approaches closest to the kick sensor 11, the output value of the kick sensor 11 becomes maximum.

After that, when the user pulls the leg F backward as illustrated in FIG. 4D, the leg F is distant from the kick sensor 11. Therefore, the output value of the kick sensor 11 decreases. Then, the user pulls the leg F further backward such that the leg F is out of the detection area A1, and the leg F has landed as illustrated in FIG. 4E. The series of motions in FIGS. 4A to 4E described above are the kicking motion of the leg F. Here, the position of the leg F in FIG. 4E is identical to the position of the leg F in FIG. 4A. That is, the kicking motion has a principle that the leg F returns to the original position upon completion of kicking, which is important in one or more embodiments of the disclosure as described later.

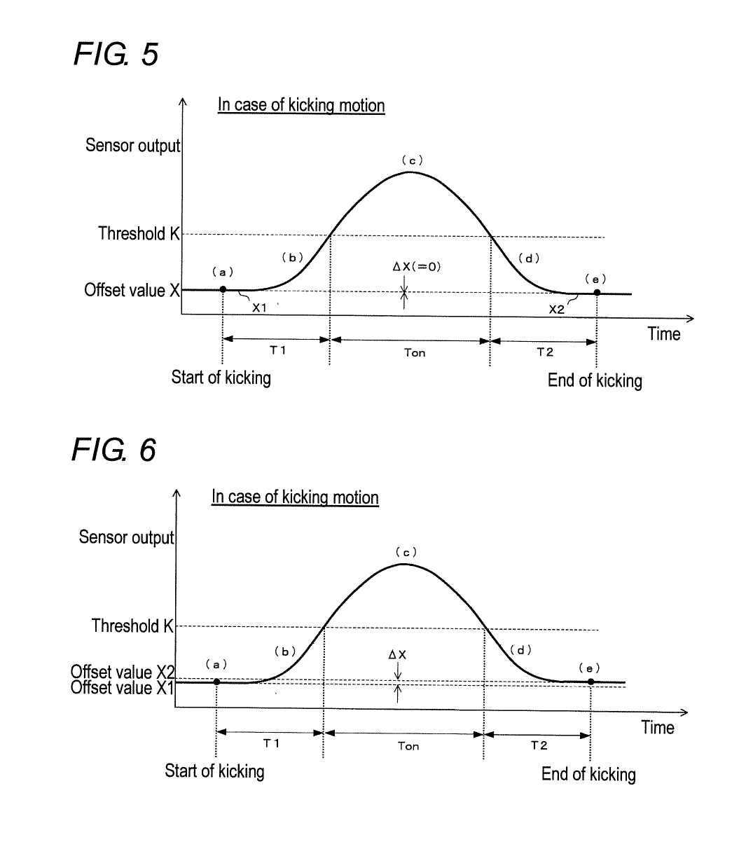

FIG. 5 is a waveform diagram of a signal output from the kick sensor 11 according to the leg motions in FIGS. 4A to 4E. The horizontal axis represents time and the vertical axis represents a sensor output value (voltage value). (a) to (e) in FIG. 5 correspond to the leg positions in FIGS. 4A to 4E, respectively.

In FIG. 5, at (a), even though the kick sensor 11 does not detect the leg F, the kick sensor 11 outputs the voltage having an offset value X1. This is because applying a bias to sensor output makes easier detection of the leg F which the user swings forward. At (b), since the leg F enters the detection area A1, the output value of the kick sensor 11 increases. At (c), the leg F approaches closest to the kick sensor 11 as described above, and the output value becomes maximum. At (d), since the leg F is distant from the kick sensor 11, the output value decreases. At (e), the leg F has landed and the output value of the kick sensor 11 becomes an offset value X2.

As illustrated in FIG. 5, a predetermined threshold K is set for the output value of the kick sensor 11 (K>X1, X2). The threshold K is stored in the threshold storage 24 (FIG. 3) of the kick detector 20. T1 is a time period from when the kicking motion starts until when the output value of the kick sensor 11 exceeds the threshold K. Ton is a time period in which the output value of the kick sensor 11 exceeds the threshold K. T2 is a time period from when the output value of the kick sensor 11 falls below the threshold K until when the kicking motion ends.

In a case where the motion of the leg F is a regular kicking motion, the output value of the kick sensor 11 rises from the offset value X1 and reaches the threshold K, and then exceeds the threshold K. After the time period Ton in which the output value of the kick sensor 11 exceeds the threshold K continues for a fixed time period or longer, the output value of the kick sensor 11 falls below the threshold K and becomes the offset value X2. Here, in a case where the regular kicking motion is performed, the leg F returns to the original position as described above. Therefore, the offset value X1 before the output value of the kick sensor 11 exceeds the threshold K (time period T1) and the offset value X2 after the output value of the kick sensor 11 falls below the threshold K (Time T2) become identical offset values X (X1=X2=X). Therefore, the difference ΔX between the offset values X1 and X2 is ΔX=0.

However, even in a case where the regular kicking motion is performed, the leg position in FIG. 4E may be slightly shifted from the leg position in FIG. 4A. In this case, as illustrated in FIG. 6, the offset value X1 before the output value of the kick sensor 11 exceeds the threshold K (time period T1) and the offset value X2 after the output value of the kick sensor 11 falls below the threshold K (Time period T2) differ from each other (X1≠X2). However, since a shift of the leg position in a kicking motion is actually small, the difference ΔX between the offset values X1 and X2 is small. Note that even though X2>X1 is satisfied in FIG. 6, X2<X1 may be satisfied depending on the leg landing position.

As can be seen from FIGS. 5 and 6, in a case where the regular kicking motion is performed, the time period Ton in which the sensor output value exceeds the threshold K continues for a fixed time or longer. In addition, the offset value X1 (first output value) before the sensor output value exceeds the threshold K becomes equal to or slightly different from the offset value X2 (second output value) after the sensor output value falls below the threshold K. That is, the absolute value |ΔX| of the difference between the offset values X1 and X2 is not greater than a predetermined value. In one or more embodiments of the disclosure, it is determined whether or not a motion of the leg F is a regular kicking motion according to this principle. The detailed procedure thereof will be described later.

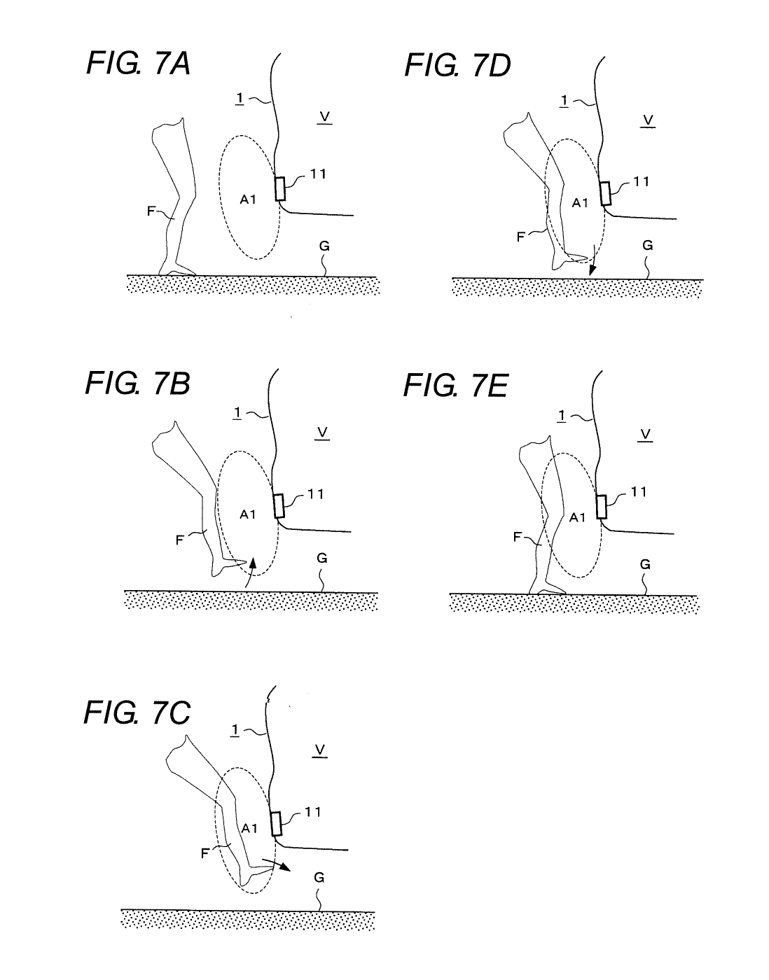

FIGS. 7A to 7E illustrate motions of the leg F other than the regular kicking motion. In FIGS. 7A to 7E, it is assumed that the kick sensor 11 detects up and down of the leg F during walking when the user approaches the rear part of the vehicle V by walk. From the state in FIG. 7A, the user raises the leg F as illustrated in FIG. 7B, and takes one step forward as illustrated in FIG. 7C. Then, the leg F enters the detection area A1. However, since a kicking motion is not performed, the leg F lowers as illustrated in FIG. 7D, and the leg F has landed as illustrated in FIG. 7E. Here, the position of the leg F in FIG. 7E differs from the position of the leg F in FIG. 7A. That is, the leg F has not returned to the original position, but is located closer to the kick sensor 11 than the original position.

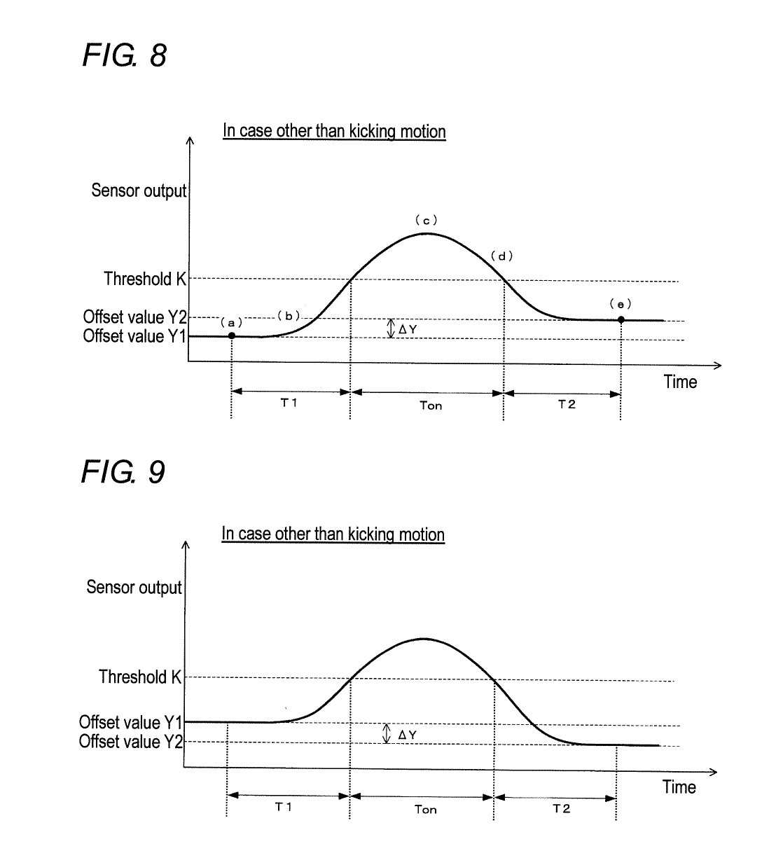

FIG. 8 is a waveform diagram of a signal output from the kick sensor 11 according to the leg motions in FIGS. 7A to 7E. The horizontal axis represents time and the vertical axis represents a sensor output value (voltage value). (a) to (e) in FIG. 8 correspond to the leg positions in FIGS. 7A to 7E, respectively.

As can be seen from FIG. 8, even in the case of walking as illustrated in FIGS. 7A to 7E, the output value of the kick sensor 11 changes as follows. The output value of the kick sensor 11 rises along with the motion of the leg F, and falls below the threshold K after the time period Ton in which the output value exceeds the threshold K continues for a fixed time or longer. However, an offset value of the kick sensor 11 before the output value of the kick sensor 11 exceeds the threshold K (time period T1) is Yl, and an offset value of the kick sensor 11 after the output value of the kick sensor 11 falls below the threshold K (time period T2) is Y2. Y2 is greater than Yl, and the difference ΔY between Y1 and Y2 is sufficiently greater than ΔX in FIG. 6. This is because the leg F is located closer to the kick sensor 11 in the state in FIG. 7E as described above.

Note that depending on the motion of the leg F, the signal output from the kick sensor may be as illustrated in FIG. 9. For example, in a case where the user pulls the leg F backward immediately after the leg F has landed and the leg F is located far away from the kick sensor 11, the offset value Y2 of the kick sensor 11 after the output value of the kick sensor 11 falls below the threshold K is smaller than the offset value Y1 before the output value of the kick sensor 11 exceeds the threshold K, as illustrated in FIG. 9. However, even in this case, the difference ΔY between Y1 and Y2 is still sufficiently greater than ΔX in FIG. 6.

As can be seen from FIG. 8 and FIG. 9, in a case where the motion of the leg F is a walking motion, the time period Ton in which the output value of the kick sensor 11 exceeds the threshold K continues for a fixed time or longer. However, the offset value Y1 (first output value) before the output value of the kick sensor 11 exceeds the threshold K differs from the offset value Y2 (second output value) after the output value of the kick sensor 11 falls below the threshold K, and the absolute value |ΔY| of the difference between the offset values Y1 and Y2 exceeds a predetermined value. In one or more embodiments of the disclosure, it is determined that a motion of the leg F is not a kicking motion according to this principle.

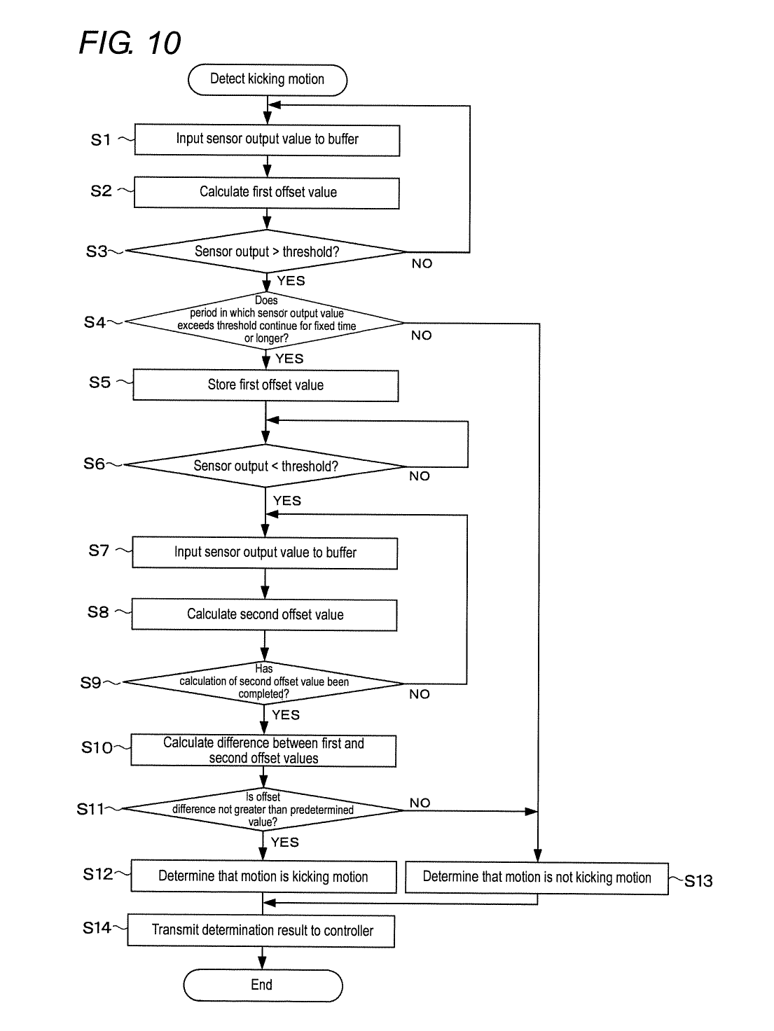

Next, the detailed procedure for detecting a kicking motion will be described with reference to the flowchart in FIG. 10. The offset calculator 22 of the kick detector 20 executes steps S1 to S10 in FIG. 10. The kicking motion determining unit 23 of the kick detector 20 executes steps S11 to S14. Note that kicking motion detection performed by the kick sensor 11 will be described below as an example; however, kicking motion detection performed by each of the other kick sensors 12 to 14 is similar.

In step S1, the buffer 21 receives and temporarily stores the output value of the kick sensor 11, that is, the voltage value (sampling value) of the signal output from the kick sensor 11. In step S2, the offset calculator 22 calculates a first offset value according to the output value that the buffer 21 stores. The first offset value is an offset value (for example, X1 in FIG. 5 and FIG. 6) in a predetermined period before the output value of the kick sensor 11 exceeds the threshold K. A method of calculating the first offset value will be described in detail below.

In step S3, the offset calculator 22 determines whether or not the output value of the kick sensor 11 exceeds the threshold K. If the output value does not exceed the threshold K (No in step S3), the process returns to step S1 and the offset calculator 22 repeats steps S1 and S2. If the output value exceeds the threshold K (Yes in step S3), the process proceeds to step S4. In step S4, the offset calculator 22 determines whether or not the period in which the output value exceeds the threshold K continues for a fixed time or longer. If the period in which the output value exceeds the threshold K continues for the fixed time or longer (Yes in step S4), the process proceeds to step S5. If the period in which the output value exceeds the threshold K does not continue for the fixed time or longer (No in step S4), the process proceeds to step S13.

In step S5, the first offset value calculated in step S2 is stored in a predetermined memory area. Subsequently, in step S6, the offset calculator 22 determines whether or not the output value of the kick sensor 11 falls below the threshold K. If the output value does not fall below the threshold K (No in step S6), the offset calculator 22 repeats step S6. If the output value falls below the threshold K (Yes in step S6), the process proceeds to step S7.

Similarly to step S2, in step S7, the buffer 21 receives and temporarily stores the output value of the kick sensor 11. In step S8, the offset calculator 22 calculates a second offset value according to the output value that the buffer 21 stores. The second offset value is an offset value (for example, X2 in FIG. 5 and FIG. 6) in a predetermined period after the sensor output falls below the threshold K. A method of calculating the second offset value will also be described in detail below.

In step S9, the offset calculator 22 determines whether or not calculation of the second offset value has been completed. If the calculation of the second offset value has not been completed (No in step S9), the process returns to step S7 and the offset calculator 22 repeats steps S7 and S8. If the calculation of the second offset value has been completed (Yes step S9), the process proceeds to step S10, and the offset calculator 22 calculates the difference (offset difference) between the first offset value and the second offset value. This offset difference is an absolute value, for example, |ΔX| in the case of FIGS. 5 and 6, and |ΔY| in the case of FIGS. 8 and 9.

In step S11, the kicking motion determining unit 23 determines whether or not the offset difference calculated in step S10 is not greater than a predetermined value. As in the cases of FIGS. 5 and 6, if the offset difference is not greater than the predetermined value (Yes step S11), the kicking motion determining unit 23 determines in step S12 that the motion detected by the kick sensor 11 is a kicking motion. In addition, as in the cases of FIGS. 8 and 9, if the offset difference is greater than the predetermined value (No step S11), the kicking motion determining unit 23 determines in step S13 that the motion detected by the kick sensor 11 is not a kicking motion. In step S14, the kicking motion determining unit 23 transmits the determination result in step S12 or S13 to the controller 30.

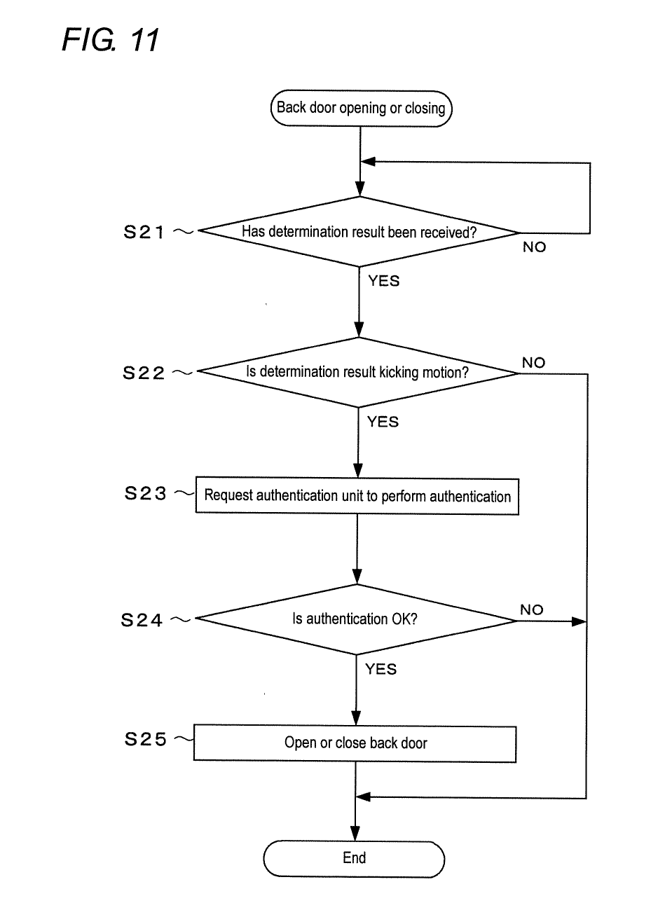

Next, the procedure for opening or closing the back door according to detection of the above-described kicking motion will be described with reference to the flowchart in FIG. 11. The controller 30 executes each step of FIG. 11.

In step S21, the controller 30 waits for reception of the determination result from the kick detector 20. When the controller 30 receives the determination result (step Yes in S21), the controller 30 determines in step S22 whether or not the determination result is a kicking motion. If the determination result is a kicking motion (Yes in step S22), the process proceeds to step S23. If the determination result is not a kicking motion (No in step S22), the controller 30 terminates the process without executing steps S23 to S25.

In step S23, the controller 30 requests the authentication unit 40 to authenticate the portable device 200. Then, in step S24, the controller 30 determines whether or not the authentication result notified from the authentication unit 40 is OK. If the authentication result is OK (Yes in step S24), the process proceeds to step S25. If the authentication result is not OK (No in step S24), the controller 30 terminates the process without executing step S25. In step S25, the controller 30 outputs a control signal for opening or closing the door to the door opening and closing unit 300 to open or close the back door 2 of the vehicle V.

As described above, automatic opening or closing of the back door 2 is performed on condition that the regular kicking motion is detected and the authentication result made by the authentication unit 40 is OK.

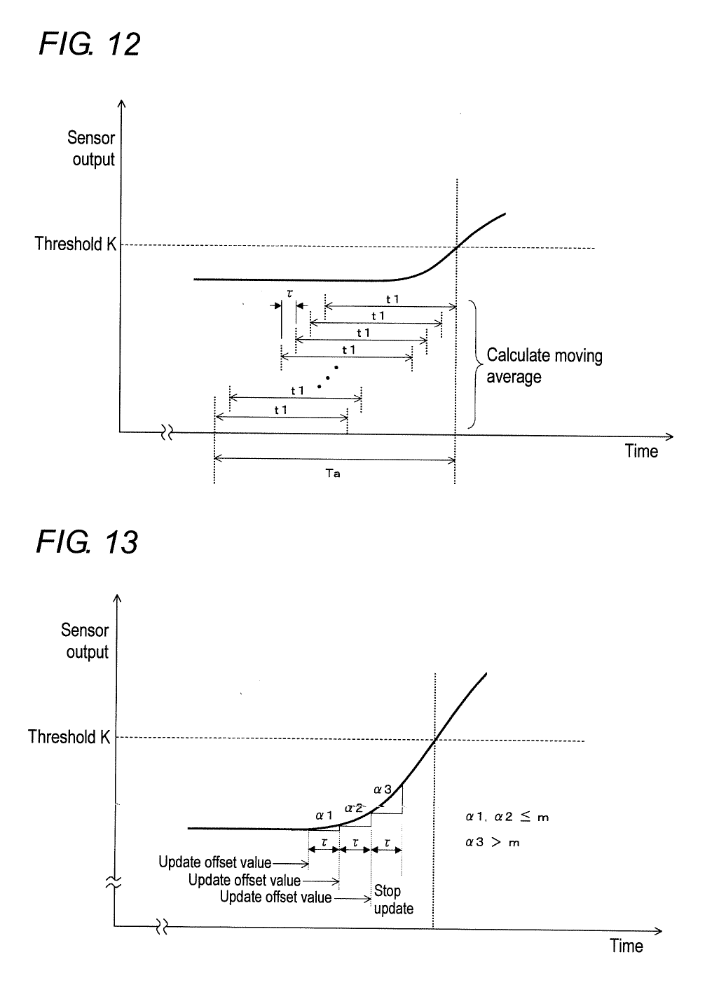

FIG. 12 is a diagram illustrating the method of calculating the first offset value in step S2 in FIG. 10. In FIG. 12, the first offset value is calculated according to the moving average in a predetermined period Ta (first period) from a time point at which the output value of the kick sensor 11 exceeds the threshold K to a time point earlier than the time point. The period Ta is part of the time period T1 illustrated in FIG. 5 and the like (Ta<T1).

More specifically, in the period Ta, processes are sequentially performed by shifting the start time by τ. In the process, the output value (sampling value) of the kick sensor 11 in a fixed time period t1 is measured and the average value of the output values within the time period t1 is calculated as the first offset value. For example, t1=100 ms, τ=10 ms, and Ta=400 ms. In parallel with this process, a process of calculating the increase rate (gradient) of the output value of the kick sensor 11 for each time period τ is performed as illustrated in FIG. 13.

When the increase rate is not greater than a fixed value m, for example, in a case where the increase rate is α1 or α2 (α1, α≤m), the first offset value is updated to the latest calculated value. In contrast, if the increase rate exceeds the fixed value m, for example, in a case where the increase rate is α3 (α3>m), subsequent Update of the first offset value is stopped. Therefore, the latest first offset value is a value calculated in the time period t1 immediately before the increase rate of the output value of the kick sensor 11 exceeds the fixed value m, and this calculated value is the first offset value stored in step S5 in FIG. 10.

As described, since the first offset value is calculated according to the moving average, the influence of noise detected by the kick sensor 11 can be eliminated, and the accuracy of the offset value can be improved. Note that the disclosure is not limited to this, and the first offset value can be calculated as a simple average of the output values in the period Ta.

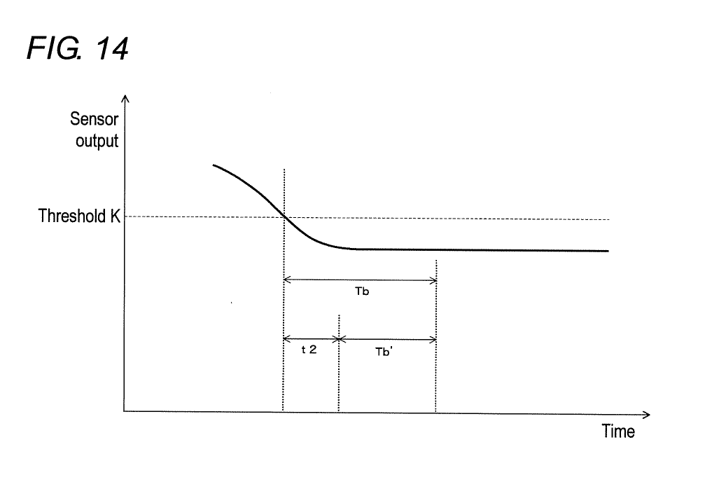

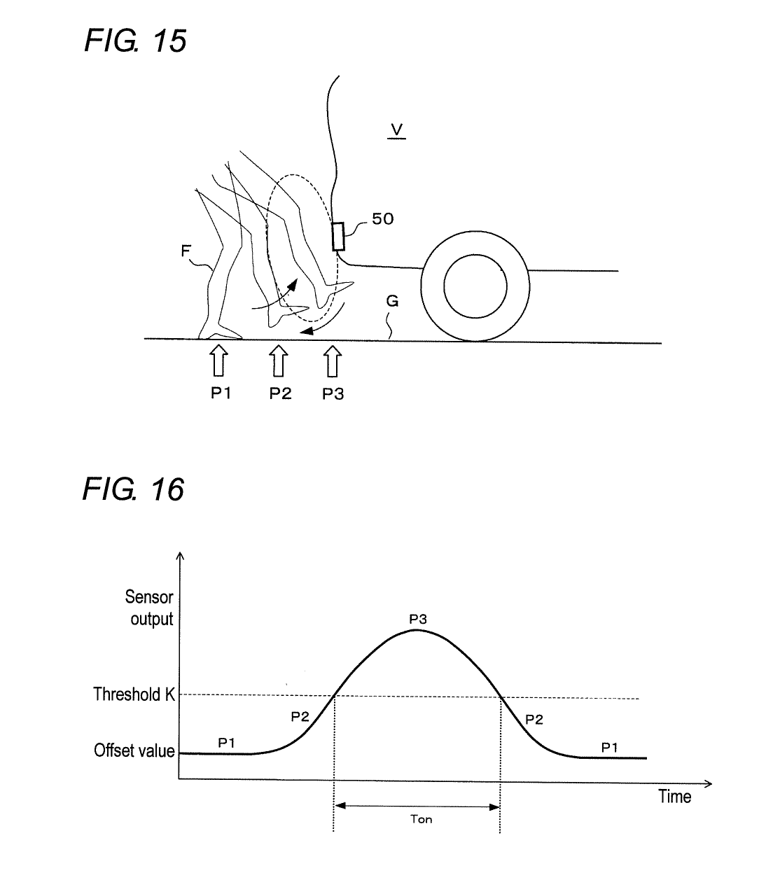

FIG. 14 is a diagram illustrating the method of calculating the second offset value in step S8 in FIG. 10. In FIG. 14, the output value (sampling value) of the kick sensor 11 during a predetermined period Tb (second period) after the time point when the output value of the kick sensor 11 falls below the threshold K is measured, the average value of the sensor output values in the period Tb is calculated by using a simple average, and this average value is set as a second offset value. The period Tb is part of the time period T2 illustrated in FIG. 5 and the like (Tb<T2).

In the case of the first offset value described with reference to FIG. 12, the period Ta needs to be set long to some extent. This is because a change in the signal output from the kick sensor 11 until the output value of the kick sensor 11 exceeds the threshold K varies depending on the individual difference of the kicking speed, the kicking-up height, or the like. In contrast, in the case of the second offset value, the period Tb may be shorter than the period Ta. For example, the period Tb may be ½ of the time period Ton (FIG. 5 and the like) when the sensor output value exceeds the threshold K. This is because, in the case of the kicking motion, according to an experiment, it is found out that the time period (Ton/2) from when the output value of the kick sensor 11 reaches the peak value to a time point at which the output value of the kick sensor 11 falls below the threshold K is substantially equal to the time period from the time point until when the leg has landed.

As described above, in a case where the period Tb is short, the influence of noise is small. Therefore, it is not necessary to calculate the second offset value by using a moving average, and it is sufficient to calculate the second offset value by using a simple average. Thus, the calculation process of the second offset value can be simplified. However, the disclosure is not limited to this. In a case where the period Tb is set to be as long as the period Ta, the second offset value may be calculated by using a moving average in a method similar to the method of calculating the first offset value.

In addition, as illustrated in FIG. 14, in lieu of the period Tb, a period Tb′ may be adopted. The period Tb′ is a period starting from a time point at which a fixed time t2 elapses after the sensor output value falls below the threshold K.

According to an illustrative embodiment, as a condition for determining a kicking motion, the condition that the difference (absolute value) between the first offset value of the kick sensor 11 before the output value of the kick sensor exceeds the threshold and the second offset value of the kick sensor 11 after the output value of the kick sensor 11 falls below the threshold is not greater than a predetermined value is added in addition to the conventional condition for determining a kicking motion. The conventional condition is that after the output value of the kick sensor 11 reaches the threshold K, the time period Ton in which the output value of the kick sensor 11 exceeds the threshold K continues for a predetermined time period or longer, and then the output value falls below the threshold K. Therefore, even if the conventional condition for determining a kicking motion is satisfied, in the case of the motion other than the kicking motion as illustrated in FIG. 7, the difference between the first offset value and the second offset value is greater, and the above additional condition is not satisfied. Therefore, it is not determined that the motion other than the kicking motion is a kicking motion and the detection accuracy can be improved.

In one or more embodiments of the disclosure, in addition to an illustrative embodiment, various embodiments described below can be adopted.

FIGS. 7A to 7E illustrate walking as a motion other than the kicking motion. However, in one or more embodiments of the disclosure, even in a case where the kick sensor 11 detects a motion of an animal, baggage, or the like, it can be determined that the above motion is not a regular kicking motion.

In an illustrative embodiment, an example is described where the first offset value is obtained by calculation; however, the first offset value may be a fixed value set in advance. In this case, only the second offset value may be calculated by the above-described method and the calculated value may be compared with the first offset value.

In an illustrative embodiment, the condition for determining the kicking motion is that the difference (absolute value) between the first offset value and the second offset value is not greater than the predetermined value. However, the condition for determining the kicking motion may be that the ratio of the first offset value to the second offset value is not greater than a predetermined value (or not less than a predetermined value).

FIGS. 10 and 11 illustrate an example where after determination as to whether or not a motion is a kicking motion is made (steps S11 to S13), determination as to whether or not authentication of the portable device 200 is OK (step S24) is made. In contrast, determination as to whether or not a motion is a kicking motion may be made after determination as to whether or not authentication of the portable device 200 is OK is made.

In FIG. 3, the kick detector 20 is provided separately from the controller 30; however, the kick detector 20 may be provided in the controller 30.

In an illustrative embodiment, an example of using the capacitive proximity sensor as each of the kick sensors 11 to 14 is described. However, another sensor such as a reflective optical sensor or an ultrasonic sensor may be used in lieu of the capacitive proximity sensor. In addition, each of the kick sensors 11 to 14 may be configured of a single sensor element or a plurality of sensor elements.

In an illustrative embodiment, an example of detecting a kicking motion of swinging a leg forward is described. However, the disclosure is not limited to this example. For example, in lieu of swinging a leg forward, a motion of only moving a leg in the front-back direction, the right-left direction, or an oblique direction may be detected. In addition, the body part to be detected is not limited to a leg, and may be an arm or the like.

In an illustrative embodiment, the case of opening or closing the back door 2 is described as an example. However, the door to be opened or closed may be a sliding door. In this case, the kick sensors 11 to 14 are provided near the sliding door on a side of a vehicle. In addition, the door to be opened or closed may be a door for opening and closing a trunk.

While the invention has been described with reference to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A vehicle door opening and closing control device comprising:
a sensor provided near a door of a vehicle and configured to detect a motion of a body part of a user;
a determining unit configured to determine whether or not the motion that the sensor detects is a predetermined motion; and
a controller configured to perform one of an opening operation and a closing operation of the door of the vehicle in a case where the predetermined motion is performed,
wherein a threshold is set for an output value of the sensor, and
wherein in a case where after the output value of the sensor reaches the threshold, a period in which the output value of the sensor exceeds the threshold continues for not less than a fixed time, and then the output value of the sensor falls below the threshold, the determining unit compares a first output value of the sensor before the output value of the sensor exceeds the threshold and a second output value of the sensor after the output value of the sensor falls below the threshold, and in a case where both the first output value and the second output value satisfy a predetermined condition, the determining unit determines that the predetermined motion is performed.

2. The vehicle door opening and closing control device according to claim 1,
wherein the determining unit determines that the predetermined condition is satisfied in a case where an absolute value of a difference between the first output value and the second output value is not greater than a predetermined value, and
wherein the determining unit determines that the predetermined condition is not satisfied in a case where the absolute value of the difference between the first output value and the second output value is greater than the predetermined value.

3. The vehicle door opening and closing control device according to claim 1,
wherein the first output value is a first offset value that the sensor outputs in a state where the sensor does not detect the motion of the body part, and
wherein the second output value is a second offset value that the sensor outputs in a state where the sensor does not detect the motion of the body part.

4. The vehicle door opening and closing control device according to claim 3 further comprising a calculator configured to calculate the first offset value and the second offset value,
the calculator calculating the first offset value by calculating an average value of output values of the sensor in a predetermined first period before the output value of the sensor exceeds the threshold, and
the calculator calculating the second offset value by calculating an average value of output values of the sensor in a predetermined second period after the output value of the sensor falls below the threshold.

5. The vehicle door opening and closing control device according to claim 4, wherein the calculator calculates the first offset value by using a moving average of the output values in the predetermined first period.

6. The vehicle door opening and closing control device according to claim 5, wherein the first offset value is a value calculated immediately before an increase rate of the output value of the sensor exceeds a fixed value.

7. The vehicle door opening and closing control device according to claim 4, wherein the calculator calculates the second offset value by using a simple average of the output values in the predetermined second period.

8. The vehicle door opening and closing control device according to claim 1, wherein in a case where the predetermined condition is satisfied, the determining unit determines that the motion detected by the sensor is a kicking motion of a leg.
